(19) United States
(12) Patent Application Publication
(10) Pub. No.: US 2011/0083298 A1
(43) Pub. Date: Apr. 14, 2011

(54) Wheel seat reinforcement structure

(76) Inventor: Li-Lan Yan, Puzih City (TW)

(21) Appl. No.: 12/588,277

(22) Filed: Oct. 9, 2009

(51) Int. Cl. B60B 33/00

(52) U.S. Cl. 16/31 R

(57) ABSTRACT

This invention relates to a wheel seat reinforcement structure, in which a rotary shaft is provided on the wheel seat and a teeth portion is provided on the bottom end of the rotary shaft. A cover body extended on the wheel seat and having a left and a right rib strips for partial shielding is provided at both sides of the cover body. A shaft seat for mounting the wheel body is provided at the center of left and a right rib strips. An auxiliary connection seat is extended from the lower side of the shaft seat to the cover body. In this manner, when the shaft seat of the wheel seat is subject to the action of external force, the force can be uniformly distributed on both sides. Further, together with the support on the bottom portion, better reinforcement support effect can be achieved.

### BACKGROUND OF THE INVENTION

1. Field of the Invention

This invention relates to a wheel seat reinforcement structure, especially to a wheel seat having support strength, in which auxiliary support means are provided at both sides and the bottom of the shaft seat of the wheel seat so as to achieve the above effect.

2. Brief Description of Prior Art

Invention of wheel has triggered the new age of civilization from foot-drive into mechanical rolling which is currently applied in widespread range such as sedan, truck, linked vehicle etc. Particularly, small wheel has been applied skillfully in hand-push mechanism such as cart, baby stroller which brings much convenience in our daily life.

The structure of wheel is substantially disclosed in Taiwanese Patent No. M279516 entitled “Wheel Seat Body Having Brake Device”, comprising: a rotary shaft for supporting and inserting into the wheel seat body, which has a teeth disk provided at the bottom end; a base including a cover body, a shaft seat and an eccentric support body supporting between the cover body and the shaft seat, the rotary shaft being pivoted at the upper side of the cover body, the upper end of the eccentric support body being contacted with the lower side of the cover body at a place deviated from the central axis and the lower end being contact with the shaft seat, a projecting post being provided transversely at the inner side of the upper support segment and a projecting rib being provided appropriately on the lower support segment of the eccentric support body; a pedal being pivotedly provided on the cover body; a curved brake lining the front end of which has a protruding strip for interlocking, an upper recess provided at a place on the middle segment being engaged on the projecting post of the eccentric support body so that said brake lining can conduct bobbing with the projecting post as fulcrum, a wing blade being extended from a place on the rear segment; a restoring spring having one end abutted against the lower side of the brake lining, and the other end abutted against the rib extended from the eccentric support body; and at least one wheel which pivots on the shaft seat. In this manner, when the pedal is treaded down to press the rear segment of the brake lining downward, a resistance is produced by the contact between the wing blade of the brake lining and the wheel so that the protruding strip at the front end of the brake lining is interlocked into the gap between the teeth of the gear disk, and then the base and the wheel become non-rotatable.

In the above illustrated structure, the eccentric support body is utilized to support the shaft seat. So, when the wheel seat body is subject to the action of external force, the shaft seat will be slanted or ruptured easily, as the shaft seat has support effect only on one side and are often hollow on the other sides due to the consideration of assembly problem.

A wheel having positioning and brake device is disclosed in a Taiwanese Patent No. 355832, comprising a wheel frame, a positioning unit, a rotating unit, and a wheel unit, wherein the wheel frame has a main body in which a through hole and a recess are provided for assembling with the rotating unit and the positioning unit respectively; the rotating unit including a rotating pin, a fixed block, an upper bearing, and a lower bearing which are all provided within the through hole of the wheel frame; the wheel unit including pairs of wheel and axle provided at both sides of the wheel frame. Inasmuch as ordinary wheel are made by plastic material, reinforcement side plates are provided at both sides of the wheel frame starting from the axle aperture. Thus, the rotating unit and the positioning unit have to be inserted from the space under the axle so as to conduct assembling. Therefore, the assembling is very inconvenient.

In view of the above facts, the inventor of the present invention provides a new wheel seat reinforcement structure according to the improvement conducted on structure and disadvantages of prior art, based on his abundant experience in development and professional manufacturing in relevant field, so as to attain the goal of obtaining better implementation effectiveness and value.

### SUMMARY OF THE INVENTION

In order to improve the disadvantage of single side support happened in prior art, the main object of the present invention is to provide a wheel seat reinforcement structure in which design of auxiliary supports are all provided at both sides and the bottom of the wheel seat so as to achieve a wheel seat structure having sufficient support strength.

The object and effectiveness of the wheel seat reinforcement structure of the present invention can be realized by the following skill:

A wheel seat reinforcement structure, in which a rotary shaft is provided on said wheel seat and a teeth portion is provided on the bottom end of said rotary shaft; a cover body extended on the wheel seat and having a left and a right rib strips for partial shielding being provided at both sides of said cover body, a shaft seat for mounting the wheel body being provided at the center of left and a right rib strips, an auxiliary connection seat being extended from the lower side of the shaft seat to the cover body. In this manner, when the shaft seat of the wheel seat is subject to the action of external force, the force can be uniformly distributed on both sides. Further together with the support on the bottom portion, excellent reinforcement support effect can be achieved.

In a preferred embodiment of the wheel seat reinforcement structure of the present invention, the auxiliary connection seat is extended from the shaft seat downwardly to the cover body so as to form an enlarged hollow region between the left and right rib strips. The brake lining and the elastic member can be inserted and assembled from the enlarged region at the lateral side. Therefore, the assembling of brake lining etc. becomes very convenient.

In a preferred embodiment of the wheel seat reinforcement structure of the present invention, a brake lining is further provided to mesh mutually with the teeth portion at the bottom end of the rotary shaft, and the brake lining is combined with a pedal seat exposed on the cover body so as to be controlled to conduct braking operation.

In a preferred embodiment of the wheel seat reinforcement structure of the present invention, a brake lining is further provided to mesh mutually with the teeth portion at the bottom end of the rotary shaft, and a metal teeth seat is mounted on the brake lining so as to mesh on the teeth portion at the bottom end of the rotary shaft. In this manner, perfect and precise braking effect can be achieved.

### BRIEF DESCRIPTION OF THE DRAWINGS

FIG. 1 is a perspective exploded schematic view showing the wheel seat reinforcement structure of the present invention.

FIG. 2 is an appearance schematic view seen from one side of the wheel seat reinforcement structure of the present invention.

FIG. 3 is an appearance schematic view seen from the other side of the wheel seat reinforcement structure of the present invention.

FIG. 4 is a partial sectional schematic view showing the wheel seat reinforcement structure of the present invention.

FIG. 5 is sectional schematic view showing the wheel seat reinforcement structure of the present invention.

FIG. 6 is a schematic view showing the brake lining of the present invention.

FIG. 7 is a schematic view showing the baking operation of the present invention.

FIG. 8 is a schematic view showing the baking operation of the present invention.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

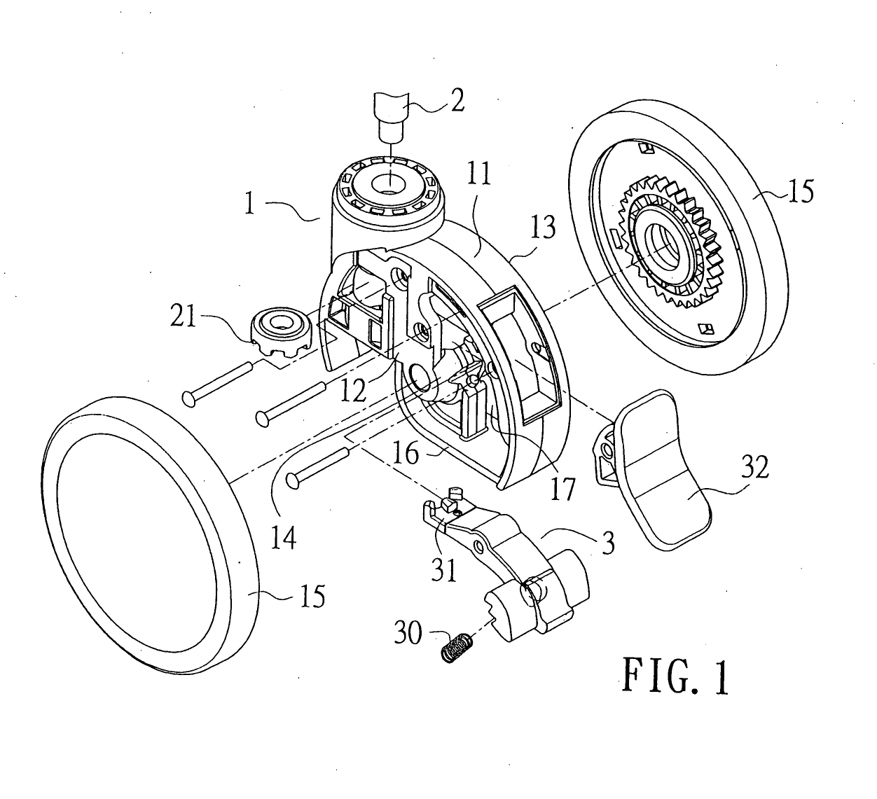

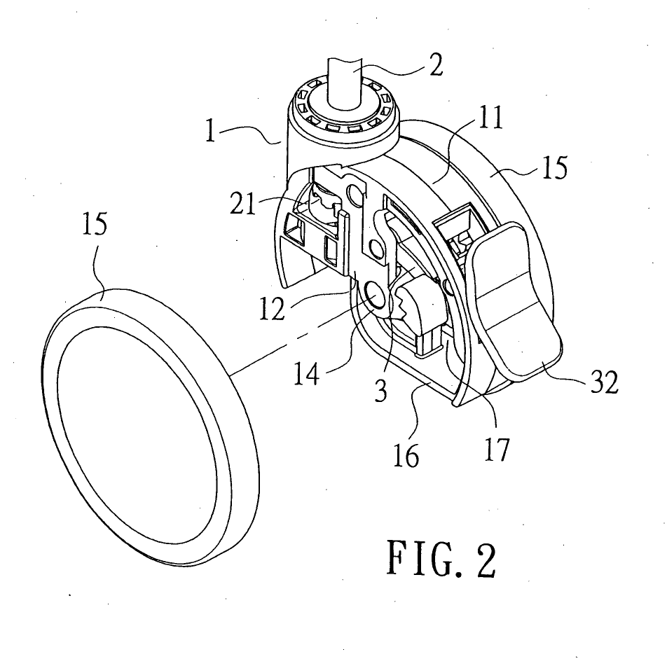

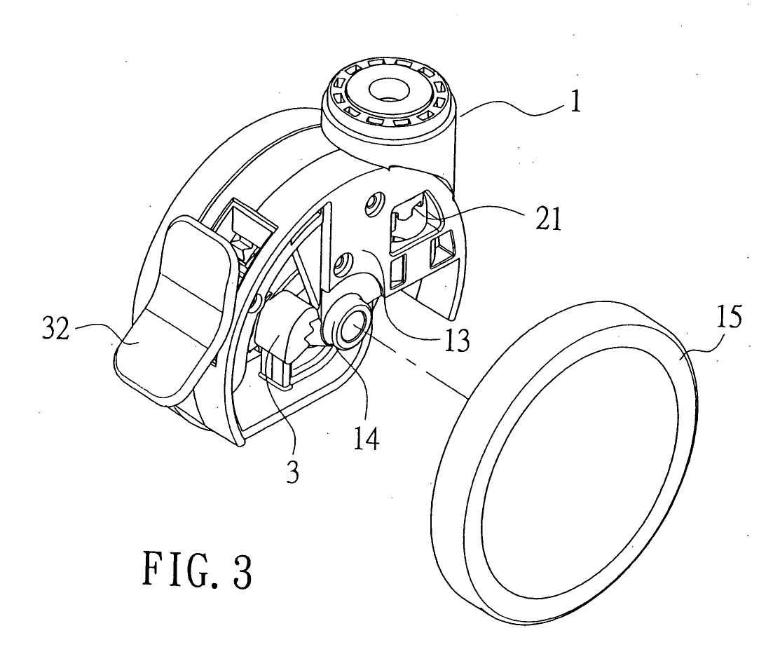

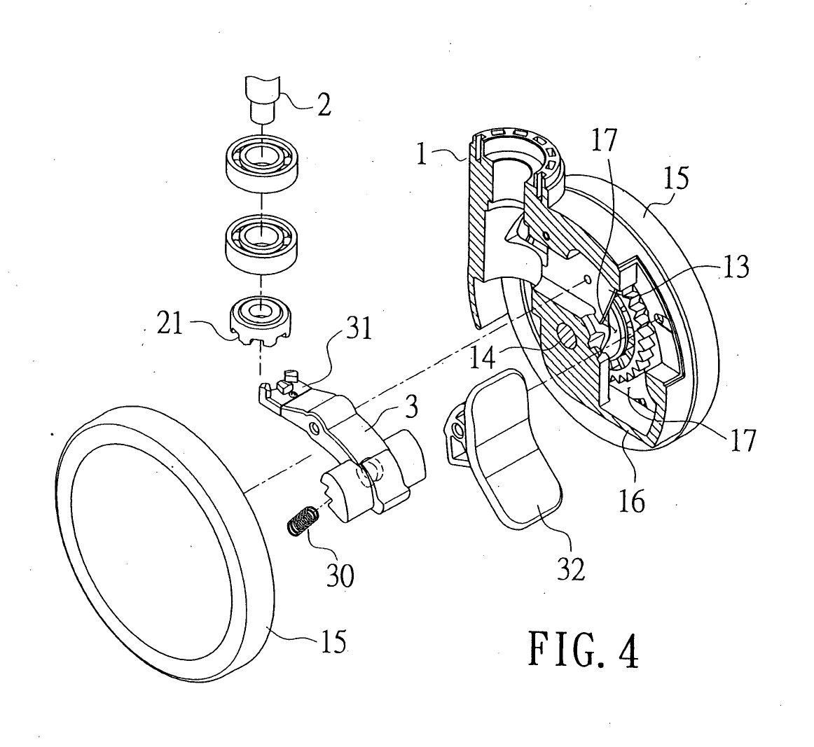

FIGS. 1 to 4 are respectively perspective exploded schematic views of the wheel seat reinforcement structure of this invention. As shown in these figures, the wheel seat reinforcement structure essentially has a cover body (11) extended on the wheel seat (1). A left and a right rib strips (12), (13) for partial shielding are provided from both sides toward the center of the cover body (11), and a central shaft seat (14) for mounting the wheel body (15) is coupled between the left and the right rib strips (12), (13). An auxiliary connection seat (16) is extended from lower side of the shaft seat (14) to the cover body (11). An enlarged hollow region (17) is formed intermediately from the left and the right rib strips (12), (13) to the auxiliary connection seat (16).

In this manner, when the shaft seat (14) of the wheel seat (1) is subject to the action of external force, the force can be uniformly distributed on both sides. Further, together with the support on the bottom portion, better reinforcement support effect can be achieved.

Moreover, a rotary shaft (2) is provided on the wheel seat (1) and a teeth portion (21) is provided on the bottom end of the rotary shaft (2). A brake lining (3) is provided to mesh mutually with the teeth portion (21), and the brake lining (3) is combined with a pedal seat (32) exposed on the cover body (11). A metal teeth seat (31) is mounted on the brake lining (3) so as to mesh mutually with the teeth portion (21) at the bottom end of the rotary shaft (2). In this manner, perfect and precise braking effect can be achieved.

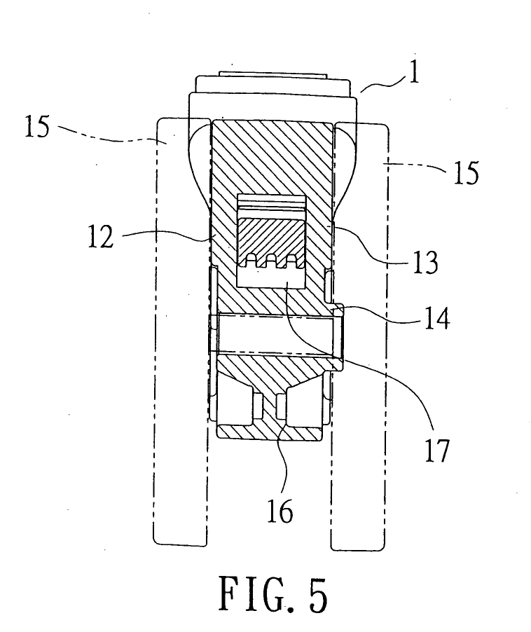

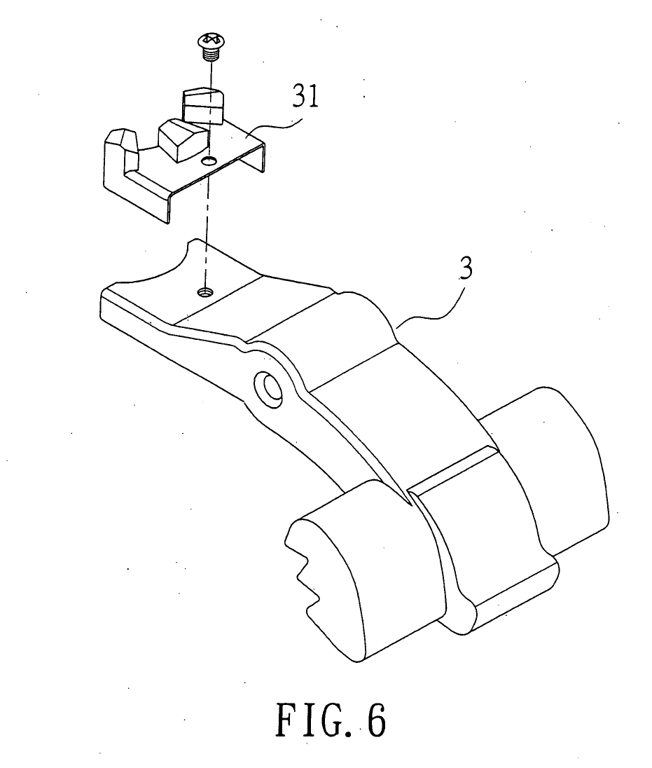

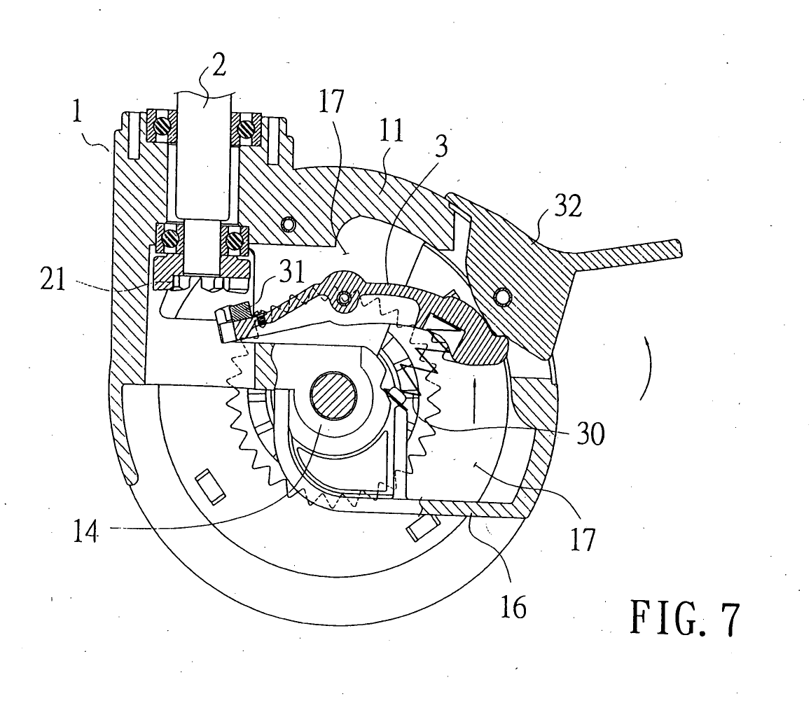

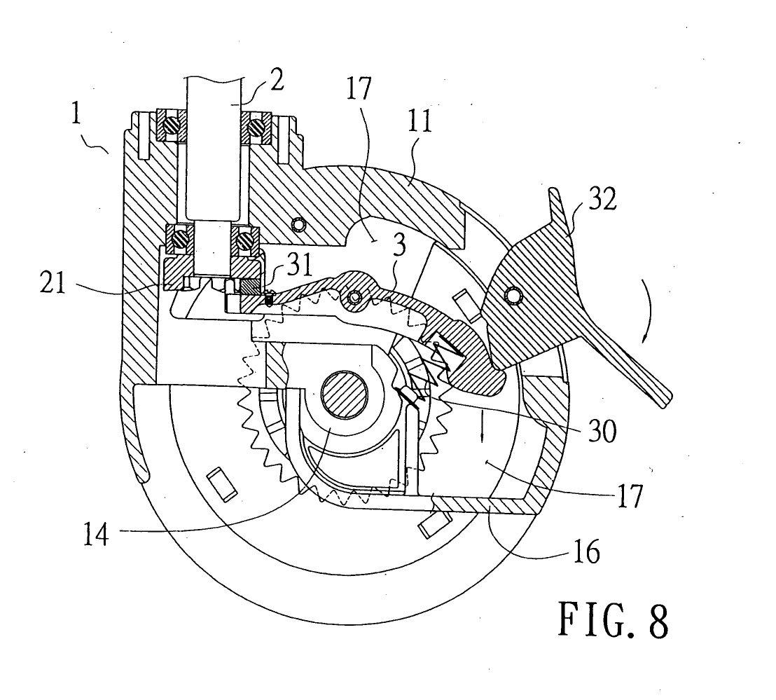

FIGS. 7 and 8 are schematic views showing the baking operation of the wheel seat reinforcement structure of the present invention. Referring to FIGS. 1 to 8, during usage of the wheel seat (1), the wheel body (15) should be contacted on ground so that the wheel seat (1) is subject to the action of external force due to the running on undulated and uneven road segment or the bearing of load weight on the wheel body (15) itself. Therefore, the shaft seat (14) gets required support from the extension of the left and the right rib strips (12), (13) and the auxiliary connection seat (16) having its lower side extended to the cover body (11), so as to achieve better reinforcement support effect.

When the brake lining (3) is assembled to the rotary shaft (2) and the teeth portion (21) on the wheel seat (1), the brake lining (3) is inserted and mounted from an enlarged hollow region (17) formed between an extension of the auxiliary connection seat (16) from the shaft seat (14) downwardly to the lateral side of the cover body (11) and the left, right rib strips (12), (13). In other words, the brake lining (3) and the elastic member (30) are inserted into the wheel seat (1) through the enlarged hollow region (17) so as to mesh with the teeth portion (21) of the rotary shaft (2). In this manner, it is more convenient to assemble the brake lining (30) and the elastic member (30). In turn, the other end of the brake lining (3) is combined with a pedal seat (32) exposed on the cover body (11) so that metal teeth seat (31) on the brake lining (3) is meshed mutually with the teeth portion (21) on the bottom end of the rotary shaft (2) to conduct the braking operation, when the pedal seat (32) on the wheel seat (1) is treaded.

The abovementioned embodiment and drawings are not intended to restrict the structural aspect or the dimensions of the present invention. Appropriate variations and modifications made by the person having ordinary knowledge in the art without departing from the spirit and scope of the present invention are still regarded to be within the scope of the present invention.

Based on the foregoing, the wheel seat reinforcement structure of the present invention indeed has the following advantages, when comparing with prior art:

1. In the wheel seat reinforcement structure, a design enabling assistance for support is provided on both sides and the bottom of the shaft seat such that the wheel seat structure having sufficient support strength is achieved.

2. In the wheel seat reinforcement structure, the auxiliary connection seat is extended from the shaft seat downwardly to the lateral side of the cover body and is formed with an enlarged hollow region between the auxiliary connection seat and the left, right rib strips which only take partial area. In this manner, it is more convenient to assemble to brake lining and the elastic member.

3. In the wheel seat reinforcement structure, a metal teeth seat is assembled on the brake lining which can mesh with the teeth portion on the bottom end of the rotary shaft without damage happened.

Summing up above, the embodiment of the present invention is surely able to reach expected effectiveness in application, and the specific structure disclosed herein is not only unprecedented in the same category of product but also not open to the public before application.

What is claimed is:

1. A wheel seat reinforcement structure, wherein it essentially has a cover body extended on the wheel seat (1), a left and a right rib strips for partial shielding being provided from both sides toward the center of the cover body, and a central shaft seat for mounting the wheel body being coupled between the left and the right rib strips, an auxiliary connection seat being extended from lower side of the shaft seat to the cover body, and an enlarged hollow region being formed between said left, right rib strips and the auxiliary connection seat.

2. A wheel seat reinforcement structure as claimed in claim 1, wherein a rotary shaft is provided on said wheel seat and a teeth portion is provided on the bottom end of the rotary shaft, a brake lining being provided to mesh mutually with the teeth portion, and the brake lining being combined with a pedal seat exposed on the cover body, a metal teeth seat being mounted on the brake lining so as to mesh mutually with the teeth portion at the bottom end of the rotary shaft to conduct braking operation.
